(19) United States
(12) Patent Application Publication
(10) Pub. No.: US 2025/0378468 A1
(43) Pub. Date: Dec. 11, 2025

(54) SYSTEMS AND METHODS FOR INCREASING CONTENT INTERACTIONS OF USERS

(71) Applicant: GOOGLE LLC, Mountain View, CA (US)

(72) Inventor: Logan Fortune, Mountain View, CA (US)

(21) Appl. No.: 18/738,885

(22) Filed: Jun. 10, 2024

(51) Int. Cl. G06Q 30/0251

(52) U.S. Cl. CPC G06Q 30/0255

(57) ABSTRACT

A method for increasing content interactions of users includes receiving approval data indicative of a pool of individuals for whom inclusion in a campaign of a content sponsor has been approved by the content sponsor, determining that content of the content sponsor is to be presented to a user of a client device, selecting, based on one or more user signals representing one or more online activities of the user, an individual from the pool of individuals to be included in a content item of the content sponsor, and generating a modified content item. Generating the modified content item includes identifying bounds of a replaceable region of the content item and inserting an image of the selected individual within the identified bounds of the content item. The method also includes causing the modified content item to be served to the client device for presentation to the user.

### FIELD OF TECHNOLOGY

The present disclosure relates to techniques for increasing users' interactions with content items (e.g., views, clicks, etc.) and, more specifically, to systems and methods that effectively and efficiently leverage the familiarity users have with particular individuals to achieve that end.

### BACKGROUND

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

Digital advertising has become a highly technical field in which content providers (advertisers) set up, maintain, and continuously modify “campaigns” that attempt to market the providers' products or services to a relevant audience. Within a given campaign, digital content (advertisements) for a particular product or service (or product line, etc.) is often arranged into groups associated with particular keywords and/or other parameters (e.g., audience parameters such as geographic location, user device type, etc.), with at least some of those parameters attempting to identify or specify people who are relatively likely to have an interest in the product or service. For example, a dedicated ad exchange server may use the campaign parameters, in connection with particular procedures or algorithms (e.g., auctions based on relevancy scores and keyword bid amounts of campaigns, etc.) to select particular digital advertisements to serve to specific recipients in particular contexts (e.g., in response to a user query entered in a search engine, or when a user is visiting a particular web page or using a particular mobile application, etc.).

It has long been known among advertisers that the buying decisions of many people are influenced by others who have a significant online or other media presence, including those who, aptly enough, are referred to as “influencers.” Influencers typically have a following on a social media platform, such as YouTube, that allow users to subscribe to (or otherwise follow) the influencer's original content. For their part, subscribers or followers of influencers typically have a heightened interest in the preferences, opinions, views, etc., of those influencers. As a result, digital advertisers have long known, like real-world advertisers before them, that it is worthwhile to reach out to influencers/public personages and negotiate deals for appearing in the content/ads of the digital advertisers.

For reasons of efficiency, digital advertisers typically reach out only to influencers with relatively large followings. To incorporate an influencer in a campaign, the digital advertiser conventionally must arrange an initial meeting, a photo shoot, and so on. Thus, to make the costs of the effort worthwhile, digital advertisers typically focus on the more popular influencers rather than those with followings that, while not insignificant, are relatively small. Due to the great number of influencers with smaller followings, however, this approach can, in the aggregate, result in a failure to leverage many influencers who might (collectively) cover a large fraction of the digital advertiser's relevant audience.

Accordingly, there is a need among digital advertisers to efficiently connect with influencers irrespective of the size of the influencers' followings, and to efficiently incorporate those influencers in the advertising campaigns of the digital advertisers. Moreover, there is a need to accomplish this in a seamless manner that does not degrade the advertisers' underlying digital content or its performance (as can be quantitatively measured using any metric(s) known in the field, such as average cost per view, cost per thousand impressions, click-through rate, etc.).

### SUMMARY

Generally, in one aspect of the disclosure, a system receives (e.g., from a computing device of a content sponsor) approval data indicative of a pool of individuals (e.g., influencers) for whom inclusion in a campaign of the content sponsor (e.g., digital advertiser) has been approved by the content sponsor. At some later time, the system determines that content of the content sponsor is to be presented to a user of a client device who is accessing a particular information resource (e.g., a search engine, web page, mobile application screen, etc.). The system also selects, based at least on one or more user signals representing one or more online activities of the user (e.g., influencer subscriptions, videos previously viewed, etc.), an individual, from the pool of individuals, who is to be included in a content item (e.g., digital advertising asset/image) of the content sponsor. In other implementations, the system makes the selection based on one or more other signals, such as information associated with the content sponsor (e.g., information in a content item or landing page of the content sponsor, or information about the content sponsor itself, etc.). In either implementation, the system can better ensure relevancy of the selected individual to the content sponsor's campaign and desired audience. Depending on the implementation, the determination that content of the content sponsor is to be presented to the user may occur before or after the individual is selected from the pool, or may occur in tandem with the selection process.

After the individual is selected, the system generates a modified content item, at least by identifying bounds of a replaceable region of the content item of the content sponsor and inserting an image of the selected individual within the identified bounds. In some implementations, the system also fills in at least the area between the identified bounds and the individual image, using a generative AI model such as an image-generating large language model (LLM). As the term is used herein, an “image of” an individual can be a digital photograph of the individual, or can instead be a human- and/or computer-generated (e.g., AI-generated) rendering of the individual.

After inserting the image of the individual into the content item, the system then causes the modified content item to be served to the client device for presentation to the user (e.g., directly serves the modified content item, or instructs or requests another system or server to serve the modified content item, etc.).

By incorporating an image of an individual having special relevance to the user, as determined based on one or more user signals relating to online user activity, the modified content item can advantageously increase the likelihood that the user will interact with the content item (e.g., click on the content item and be directed to a landing page of the content sponsor, which may contain information that enables the user to purchase a product or service advertised by modified content item). In the aggregate, a system capable of generating content items modified in such a user-specific manner can improve overall performance for the campaign, such as average cost per view, cost per thousand impressions, click-through rate, etc. Moreover, the technique of automatically identifying bounds and inserting the image of the individual, and in some implementations using a generative AI model to fill in the surrounding area, enables a highly efficient process. Further, the system can improve performance in one respect (by adding the image of the individual) without having to sacrifice performance in another respect (e.g., due to degraded aesthetic appeal of the content item).

In another aspect of the disclosure, to enhance the end-to-end efficiency of connecting content sponsors with individuals and their audiences, the system can provide an online dashboard with a listing of campaigns for which individuals can apply. The system may also provide content sponsors associated with those campaigns information about the individuals who have applied, and interactive controls to approve or deny the applicants. Such information and controls may be provided within a broader set of online campaign management tools that are offered to content sponsors.

In one aspect, a method for increasing content interactions of users includes: receiving, by one or more processors, approval data indicative of a pool of individuals for whom inclusion in a campaign of a content sponsor has been approved by the content sponsor; determining, by the one or more processors, that content of the content sponsor is to be presented to a user of a client device; selecting, by the one or more processors and based on one or more user signals representing one or more online activities of the user, an individual from the pool of individuals to be included in a content item of the content sponsor; generating, by the one or more processors, a modified content item, at least by (i) identifying bounds of a replaceable region of the content item, and (ii) inserting an image of the selected individual within the identified bounds of the content item; and causing, by the one or more processors, the modified content item to be served to the client device for presentation to the user.

### BRIEF DESCRIPTION OF THE DRAWINGS

FIG. 1 is a block diagram of an example system in which techniques for increasing content interactions of users can be implemented.

FIG. 2 depicts an example process, which may be implemented by the system of FIG. 1, for matching influencers to content sponsor campaigns.

FIG. 3 depicts an example online dashboard that can be used within the process of FIG. 2.

FIG. 4 depicts an example user interface of a campaign management tool that can be used within the process of FIG. 2.

FIG. 5 depicts an example process, which may be implemented by the system of FIG. 1, for incorporating a relevant influencer, from among a pool of influencers, in a content item served to a client device.

FIG. 6 depicts an example process, which may be implemented within the process of FIG. 5, for modifying a content item to include an image of a relevant influencer.

FIG. 7 depicts an example modification, and subsequent presentation, of a content item using the techniques disclosed herein.

FIG. 8 is a flow diagram of an example method for increasing content interactions of users.

### DETAILED DESCRIPTION OF THE DRAWINGS

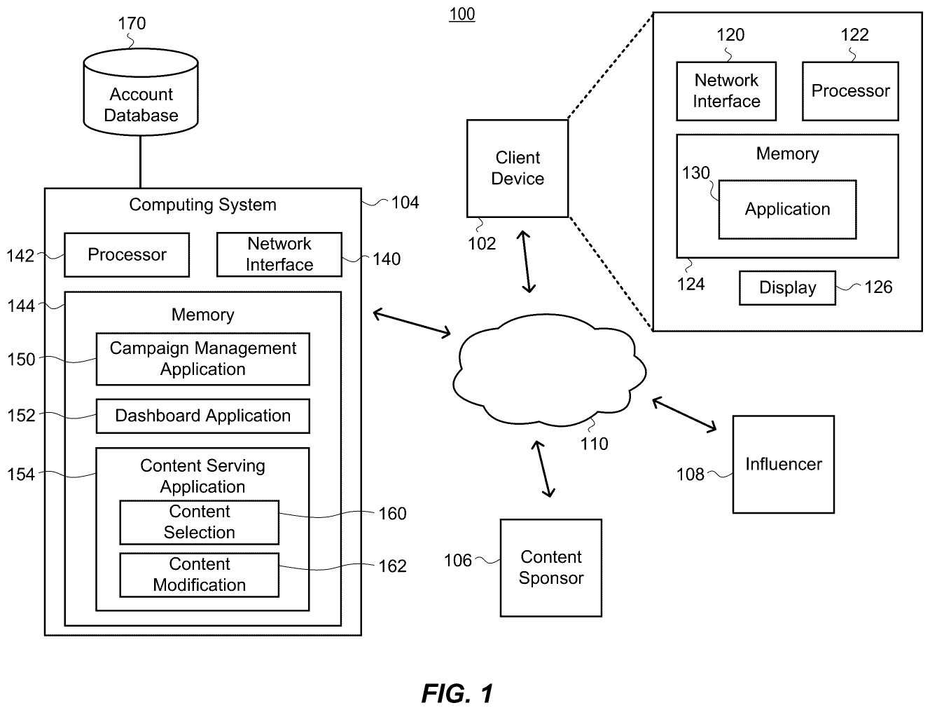

FIG. 1 is a block diagram of an example system 100 in which techniques for increasing content interactions of users can be implemented. The system 100 includes a client device 102 (e.g., a device of a user/consumer), a computing system 104 (e.g., an ad exchange server), a content sponsor 106 (e.g., a computing device of a digital advertiser), an influencer 108 (e.g., a computing device of an influencer), and a network 110. The computing system 104 is remote from the client device 102, content sponsor 106, and influencer 108, and is communicatively coupled to the client device 102, content sponsor 106, and influencer 108 via the network 110.

The network 110 may be a single communication network (e.g., the Internet), and in some implementations also includes one or more additional networks. As just one example, the network 110 may include a cellular network, the Internet, and a server-side local area network (LAN). While FIG. 1 shows only a single client device 102, content sponsor 106, and influencer 108, it is understood that the computing system 104 may also be in communication with a number (e.g., thousands or millions) of other client devices, content sponsors, and influencers that are generally similar to the client device 102, content sponsor 106, and influencer 108, respectively.

Generally, computing system 104 may provide advertising services to content sponsors (e.g., digital advertisers) such as content sponsor 106, to facilitate the marketing of commercial products and/or services of the content sponsors. To this end, computing system 104 may provide an online interface for content sponsor 106 and others to set up and maintain their own digital advertising accounts. Digital advertising accounts can include any suitable settings and/or parameters that the content sponsors can configure to manage their digital advertising efforts. For example, the online interface may enable content sponsor 106 to set up, within an account of content sponsor 106, a number of digital advertising campaigns associated with different areas of the business of the content sponsor 106, or different product lines, etc. Within a single campaign, the content sponsor 106 may select keywords based on expectations of which types of user queries might be entered by users interested in particular products or services of content sponsor 106, and link those keywords (or particular groups of those keywords, e.g., arranged based on product) to particular content items (e.g., digital assets in the form of text, images, videos, and/or audio) or to particular sets of content items that content sponsor 106 wishes to use for the particular products or services. The content sponsor 106 may also set other parameters, such as bid amounts for specific keywords. As discussed in further detail, the online interface may also enable content sponsor 106 to approve specific individuals (e.g., influencers such as influencer 108) for inclusion in their digital advertising.

Generally, an “influencer” (e.g., influencer 108) is an individual with some degree of online or other digital media presence. For example, an influencer may be a creator of original content (e.g., video content) that is available to users via one or more online channels. For example, an influencer may be a creator of, and/or heavily featured within, video content available via a social media platform. In some implementations and/or scenarios, the social media platform may support a mechanism for users to register their interest in (e.g., follow or subscribe to) the influencer. While the term “influencer” is used throughout this disclosure, it is understood that the techniques disclosed herein can generally apply to any individual regardless of whether that individual is, or is not, considered to be an “influencer” under any particular definition of the term.

Collectively, the settings of the campaign, possibly including any hierarchical arrangement of the campaign (e.g., within a higher-level account), and including any keywords, keyword or digital asset grouping, associations between account elements such as campaigns, keywords, digital asset groups, etc., and so on may be stored as account data of content sponsor 106, within an account database 170 that persistently stores the account data of any suitable number of content sponsors.

Computing system 104 may use the account data of the various content sponsors to select and serve/deliver (or cause the service/delivery of) specific content items to specific user client devices (e.g., client device 102) based on a suitable content selection procedure. For example, computing system 104 may select digital assets by using an auction based on keyword bids as well as other factors (e.g., a relevancy score for a particular content item given a particular query entered by a client device user, or given a particular context in which a user is using a client device, etc.). As just one example, a user of the client device 102 may access a search engine via a web page hosted by another computing system, or via a search engine application (e.g., mobile application) that was previously installed on the client device 102, and computing system 104 may (1) select one or more content items of one or more content sponsors based on queries entered by the user, and (2) cause the selected content item(s) to be served to the client device 102 for presentation to the user.

In some implementations, computing system 104 provides only some of the functionality discussed herein (e.g., only selecting and modifying content, without providing an online dashboard or campaign management tools). However, it is understood that computing system 104 may itself, in some implementations, include multiple servers and/or other devices (e.g., a first server supporting creation and maintenance of campaign/account data, a second server supporting an online dashboard, and a third server that selects content items and modifies the content items, where appropriate, so as to include influencer images).

In some implementations, content items of content sponsors are associated with links to particular landing pages. For example, if a user clicks on a content item presented via client device 102 (e.g., within a web browser or mobile application user interface), the user may be transferred to a URL of a web page selling the advertised product or service, or may be transferred (e.g., via a deeplink) to a particular page/screen of a mobile application where the product or service is offered for sale, etc.

The client device 102 may be or include any stationary, mobile, or portable computing device with wired and/or wireless communication capability (e.g., a smartphone, a tablet computer, a laptop computer, a desktop computer, a smart wearable device such as smart glasses or a smart watch, a vehicle head unit computer, etc.). In the example implementation of FIG. 1, the client device 102 includes a network interface 120, a processor 122, memory 124, and a display 126. The processor 122 may be a single processor (e.g., a central processing unit (CPU)), or may include a set of processors (e.g., multiple CPUs, or one or more CPUs and one or more graphics processing units (GPUs)).

The memory 124 includes one or more computer-readable, non-transitory storage units or devices, which may include persistent (e.g., hard disk) and/or non-persistent memory components. The memory 124 stores instructions that are executable on the processor 122 to perform various operations, including the instructions of various software applications and the data generated and/or used by such applications. In the example implementation of FIG. 1, the memory 124 stores at least an application 130. Generally, the application 130 is executed by the processor 122 to provide one or more user interfaces via display 126, where the user interface(s) may enable a user to enter and submit search queries and view (among other things) digital advertisements in response to the queries, or may otherwise enable a user to view digital advertisements within content slots of information resources. For example, the application 130 may be a web browser application or a dedicated mobile application.

The display 126 includes hardware, firmware, and/or software configured to enable a user to view visual outputs of the client device 102, and may use any suitable display technology (e.g., LED, OLED, LCD, etc.). In some implementations, the display 126 is incorporated in a touchscreen having both display and manual input capabilities. Moreover, in some implementations where the client device 102 is a wearable device, the display 126 is a transparent viewing component (e.g., lenses of smart glasses) with integrated electronic components. For example, the display 126 may include micro-LED or OLED electronics embedded in lenses of smart glasses.

The network interface 120 includes hardware, firmware, and/or software configured to enable the client device 102 to exchange electronic data with the computing system 104 via the network 110. For example, the network interface 120 may include a cellular communication transceiver, a WiFi transceiver, and/or transceivers for one or more other wired and/or wireless communication technologies.

While FIG. 1 shows client device 102 as a single component communicating directly (i.e., via network 110) with the computing system 104, in some implementations the subcomponents of client device 102 shown in FIG. 1 are instead divided among two or more user-side devices. As just one example, a pair of smart glasses may include the processor 122, the memory 124, and the display 126, while a smartphone may include another processing unit, another memory, another display, and the network interface 120. The smart glasses (or smart helmet, etc.) may then communicate as needed with the smartphone (e.g., via Bluetooth) to enable the operations described herein.

While not shown in detail in FIG. 1, the content sponsor 106 and/or the influencer 108 may represent computing devices of a content sponsor (e.g., advertiser) and/or influencer, respectively, with elements generally similar to those shown in FIG. 1 and described above with respect to client device 102 (e.g., including at least a processor, memory, display, and network interface).

The computing system 104 includes a network interface 140, a processor 142, and memory 144. The network interface 140 includes hardware, firmware, and/or software configured to enable the computing system 104 to exchange electronic data with the content sponsor 106 (and other, similar entities), and possibly client devices such as client device 102, via the network 110. For example, the network interface 140 may include a wired or wireless router and a modem. The processor 142 may be a single processor or may include two or more processors. Computing system 104 may be a single computing device at a single location, or may include multiple, coordinating computing devices that are co-located, remotely distributed, or some combination of the two.

The memory 144 is a computer-readable, non-transitory storage unit or device, or collection of units/devices, that may include persistent and/or non-persistent memory components. The memory 144 stores the instructions of a campaign management application 150, a dashboard application 152, and a content serving application 154, each of which can be executed by the processor 142.

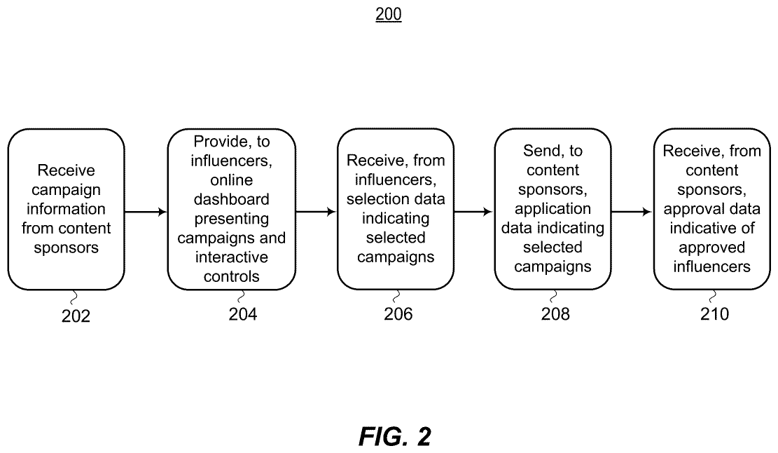

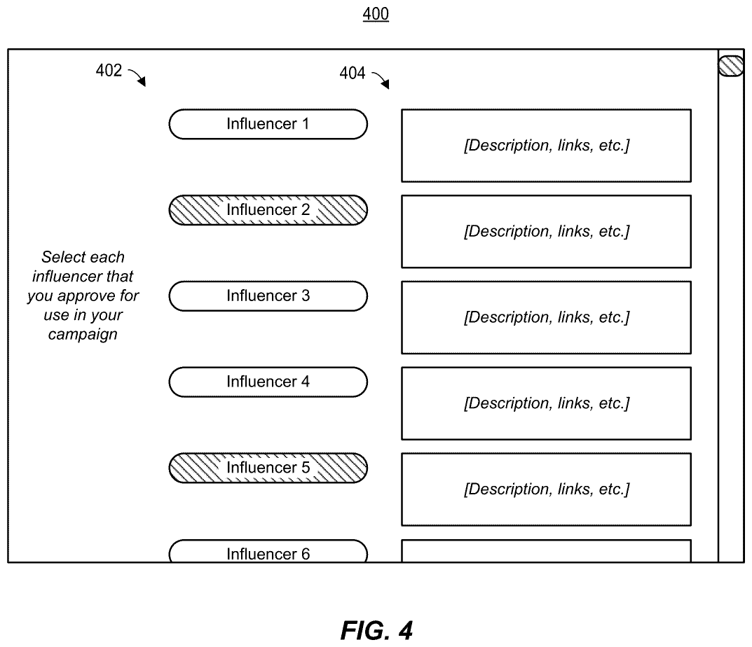

Generally, the campaign management application 150 supports/provides campaign management tools for content sponsors such as content sponsor 106. To this end, campaign management application 150 may provide user interfaces and back-end functionality that enable content sponsors to set up campaign parameters, monitor performance of their campaigns, and adjust campaign parameters in an effort to improve performance. In some implementations, campaign management application 150 provides a user interface that enables content sponsors to approve/select particular influencers for use in the content sponsors' campaigns (e.g., as discussed in further detail below in connection with FIGS. 2 and 4).

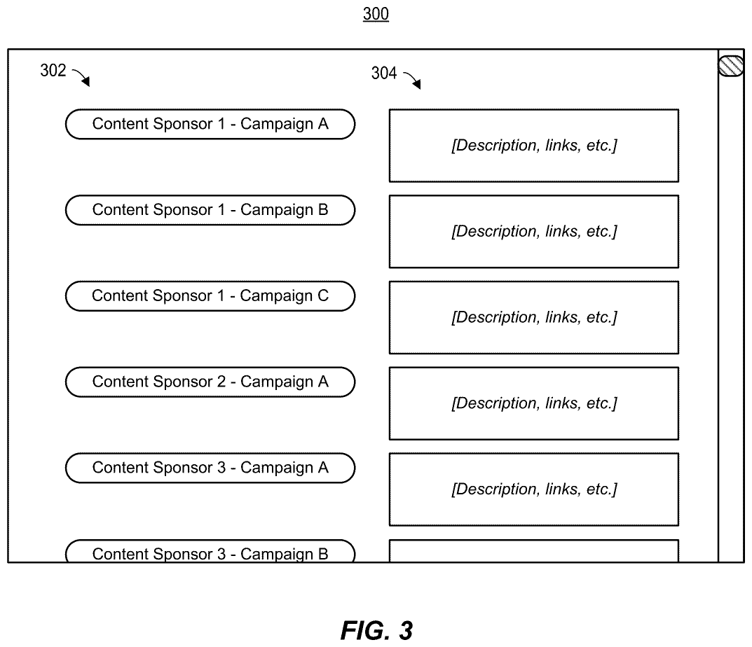

The dashboard application 152 generally supports/provides an online dashboard (user interface) that enables influencers to review information relating to campaigns of different content sponsors, and apply for any listed campaigns that the influencers are amenable to promoting (according to any applicable terms of engagement). Example online dashboards are discussed in further detail below in connection with FIGS. 2 and 3.

The content serving application 154 generally serves specific content items of content sponsors to specific client devices (e.g., client device 102) in specific contexts or circumstances. To this end, content serving application 154 includes a content selection module 160 and a content modification module 162. The content selection module 160 generally uses content sponsor campaign information from account database 170 (e.g., campaign settings/parameters, such as desired audience settings, keyword bids, etc.) and, in at least some cases, additional information, to determine which content to serve to which client device in any given circumstance. In at least some scenarios, content selection module 160 also determines which influencer, from a pool of approved influencers, to insert into such content. For a given content item (e.g., a content sponsor's original image, or video consisting of a sequence of images/frames), the content modification module 162 inserts an image of a selected influencer into the content item. Operation of content serving application 154 and its modules is discussed in further detail below.

While applications 150, 152, and 154, and modules 160 and 162, are generally shown and described as being distinct applications or modules, it is understood that these may be separate software entities, combined as a single software entity, or arranged in any other suitable manner. Moreover, it is understood that, in some implementations, the memory 144 may omit one or more of the applications shown in FIG. 1, such as application 150 and/or 152.

The operation of the example system 100 may occur according to any of the implementations described below with reference to FIGS. 2-8, for example.

FIG. 2 depicts an example process 200 that can be implemented by system 100 of FIG. 1. For example, process 200 may be implemented by software instructions stored in memory 144 (e.g., instructions of campaign management application 150 and dashboard application 152) when executed by processor 142. For ease of explanation, process 200 is described with reference to elements of system 100.

At stage 202 of process 200, computing system 104 (e.g., campaign management application 150) receives campaign information from a number of content sponsors, including content sponsor 106. The campaign information may include campaign parameters set by the content sponsors, and possibly content items (e.g., images or video) associated with the campaigns. Computing system 104 may store some or all of the campaign information in account database 170. In some implementations, the content sponsors provide the campaign information at least in part using a campaign management tool user interface hosted by the computing system 104.

At stage 204, computing system 104 (e.g., dashboard application 152) provides, to a number of influencers (including influencer 108), an online dashboard presenting a number of campaigns of the content sponsors, for consideration by the influencers, and associated interactive controls that enable the influencers to select (apply for) one or more of the campaigns shown. An example online dashboard 300 is shown in FIG. 3. The online dashboard 300 is a user interface that may be presented via displays of different influencers (e.g., via a display similar to display 126, but of a computing device of influencer 108).

The example online dashboard 300 includes interactive controls 302 for selecting (applying for) a number of campaigns of a number of content sponsors, and corresponding resources 304. The resources 304 may include brief or detailed descriptions of the campaigns and/or content sponsors (e.g., associated product and/or brand information), links to further information about the campaigns and/or content sponsors (e.g., hyperlinks to URLs associated with the content sponsors and/or their product pages), and/or other information (e.g., terms of engagement for any influencer who applies for a particular campaign and is accepted/approved by the corresponding content sponsor). In other implementations, other interactive controls and/or other elements may instead or also be included in online dashboard 300 (e.g., messaging controls that enable the influencer and content sponsor to negotiate terms in real-time, etc.).

Returning to FIG. 2, at stage 206 of process 200, the computing system 104 (e.g., dashboard application 152) receives, in response to providing the campaign information and from the computing devices of any influencers making a selection of campaign(s) via the online dashboard (e.g., via one or more interactive controls 302 of online dashboard 300), selection data indicating their respective selected campaign(s).

At stage 208, the computing system 104 (e.g., campaign management application 150) sends, to content sponsors each associated with at least one campaign selected by at least one influencer, application data indicating their respective selected campaign(s) and the influencer(s) who selected (applied for) those campaigns. In some implementations, this information may be provided to the content sponsors via user interfaces of campaign management tools that also provide other functionality (e.g., setting up campaigns, adding keywords, entering bid amounts, monitoring campaign performance, etc.). As one example, the information may be provided by the user interface 400 of FIG. 4. The example user interface 400 includes interactive controls 402 each corresponding to a different influencer who had applied (e.g., via online dashboard 300) for the campaign, as well as corresponding resources 404. The resources 404 may include brief or detailed descriptions of the influencers, their audiences, and/or online content created by the influencers, as well as other elements such as links to channels, original content, and/or further information about the influencers (e.g., hyperlinks to URLs for content created by the influencers). In other implementations, other interactive controls and/or other elements may be included in the user interface 400 (e.g., messaging controls that enable the content sponsor and influencer to negotiate terms in real-time, etc.).

FIG. 4 shows an example scenario where a content sponsor has selected two of the influencers who applied for the content sponsor's campaign (“Influencer 2” and “Influencer 5”). Selecting a particular influencer via an interactive control 402 may indicate that the content sponsor has approved the use (e.g., by computing system 104 and/or an associated entity) of that influencer in digital advertising of the content sponsor, without necessarily requiring any further input/approval from the content sponsor on a case-by-case basis when an image of the influencer is added to a content item of the content sponsor (as discussed further below).

Returning again to FIG. 2, at stage 210 of process 200, the computing system 104 (e.g., campaign management application 150) receives, in response to sending the application data and from a number of content sponsors who each selected/approved of one or more influencers (e.g., via interactive controls 402 of user interface 400), approval data indicative of the approved influencers. The computing system 104 (e.g., campaign management application 150) may store the approval data in account database 170.

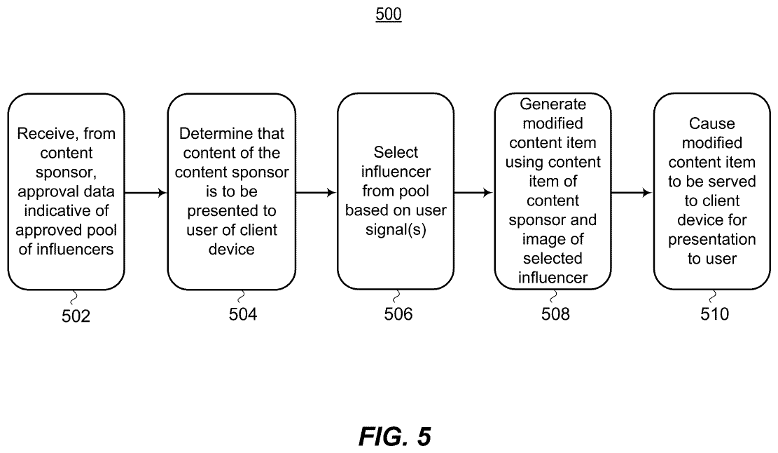

FIG. 5 depicts an example process 500, which may be a continuance of process 200, or may instead be implemented without process 200. As with process 200, process 500 may be implemented by system 100 of FIG. 1. For example, process 500 may be implemented by software instructions stored in memory 144 (e.g., instructions of campaign management application 150 and content serving application 154) when executed by processor 142. For ease of explanation, process 500 is described with reference to elements of system 100.

At stage 502 of process 500, computing system 104 (e.g., campaign management application 150) receives, from content sponsor 106, approval data indicative of an approved pool of influencers, including influencer 108. Stage 502 may represent one instance of the events described above in connection with stage 210 of process 200, for example.

At stage 504, computing system 104 (e.g., content selection module 160 of content serving application 154) determines that content of the content sponsor 106 is to be presented to a user of client device 102. For example, stage 504 may include using a trained neural network to compute a relevancy score for a content item of the content sponsor 106 (e.g., based on signals relating to the user of client device 102, client device 102 itself, a classification of the content item itself, and/or other information), and using the relevancy score (and/or other information, such as a bid amount associated with the content sponsor 106) to select the content item in accordance with a content selection process executed by content selection module 160 (e.g., an auction).

At stage 506, computing system 104 (e.g., content selection module 160) selects a particular influencer from the approved pool of influencers, based on one or more user signals representing one or more online activities of the user. For example, the user signal(s) may include data indicating that the user of client device 102 subscribed to (e.g., follows) influencer 108 or content of influencer 108. As other examples, the user signal(s) may include data indicative of one or more videos previously watched by the user of client device 102, data indicative of how much or how often the user of client device 102 watched the one or more videos, and/or data indicative of a video currently being watched by the user of client device 102.

In other implementations, such information (e.g., subscription information, or information about videos watched) may not be available to content selection module 160 due to various firewalls or other restrictions. In such an implementation, the user signal(s) can instead include other information, such as data indicative of an information resource (e.g., web page) currently being accessed by the user via the client device 102.

In some implementations, computing system 104 (e.g., content selection module 160) additionally uses one or more other, non-user signals to select the influencer 108. For example, such signals may include data indicative of the content item to be presented to the user (e.g., a category of the content item), data indicative of a landing page associated with the content item (e.g., a landing page to which a user clicking on the content item would be transferred), and/or the content sponsor 106 (e.g., a category of business in which the content sponsor 106 operates, brand restrictions of the content sponsor 106, etc.). In some implementations, at stage 506, computing system 104 (e.g., content selection module 160) uses a trained, deep neural network to select influencer 108 based on the user signals, which are applied as inputs/features to the deep neural network. The deep neural network may have been trained by computing system 104 or by another suitable computing system.

At stage 508, computing system 104 (e.g., content modification module 162) generates a modified content item using, as a starting point, a content item of the content sponsor 106. The content item may be a solitary image or a frame of video (e.g., with multiple frames being so modified). As used herein, reference to a content item “of a/the content sponsor” can encompass a content item created and/or provided by the content sponsor, or a content item created and/or provided on behalf of the content sponsor (e.g., by a third party, or by a generative artificial intelligence (AI) model of computing system 104, etc.).

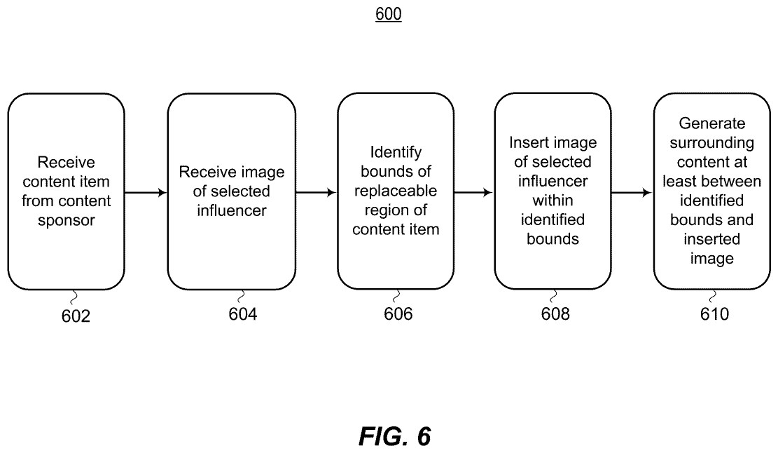

An example process 600 that may be included in stage 508 is shown in FIG. 6. At stage 602, computing system 104 (e.g., campaign management application 150) receives a content item from content sponsor 106. In other implementations, computing system 104 receives the content item from another source, or stage 602 is omitted (e.g., if computing system 104 locally generates the content item).

At stage 604, computing system 104 (e.g., campaign management application 150) receives an image of the selected influencer 108. The computing system 104 may receive the image from the influencer 108 via network 110, from another entity, or from another device, application, etc., of computing system 104 (e.g., if a usable image of influencer 108 was already stored locally).

At stage 606, computing system 104 (e.g., content modification module 162) identifies, within the content item, bounds of a replaceable region of the content item. In some implementations, for example, content modification module 162 uses a saliency classification model to identify a low-saliency area of the content item (i.e., a relatively unimportant area that can safely be covered or partially covered by the image of influencer 108), with the low-saliency area being defined by the bounds. In another implementation, content sponsor 106 (or another entity providing the content item at stage 602, etc.) provides a digital indication of an area defined by the bounds, such as a bounding box manually drawn with a software tool. In still other implementations, content modification module 162 uses an object detection model to identify a particular object in the content item (e.g., a person depicted in the content item, or a most prominently depicted person if there is more than one, etc.), and automatically generates the bounds so as to surround that object (possibly encompassing some additional margin of pixels surrounding the object itself, e.g., to facilitate a better “blending in” with the content item in stage 610 discussed below).

At stage 608, computing system 104 (e.g., content modification module 162) inserts the image of the selected influencer 108 (received at stage 604) within the bounds identified at stage 606. Content modification module 162 may insert the influencer image by overlaying the influencer image at a position entirely within the identified bounds, for example.

At stage 610, computing system 104 (e.g., content modification module 162) generates surrounding content that at least fills the area, if any, between the bounds identified at stage 606 and the influencer image inserted at stage 608. For example, content modification module 162 may generate the surrounding content in a manner that seamlessly blends with the adjoining areas of the content item, using a generative AI model such as an image-generating large language model (LLM).

In some implementations, the process 600 includes one or more additional stages. In one such implementation, content modification module 162 uses a generative AI model to modify text of the content item (e.g., text outside of the identified bounds) based on information associated with the selected influencer. For example, content modification module 162 may modify the text so as to include a name of the influencer (e.g., within a sentence of an advertisement).

Additionally or alternatively, in some implementations, content modification module 162 uses a generative AI model to modify the image of the influencer (before, after, or during insertion of the influencer image) based on the content item and/or the content sponsor 106. For example, content modification module 162 may, in cases where the influencer has given permission, ensure that the influencer image looks different (e.g., by changing a pose or expression of the influencer) for the content items of different content sponsors, and/or adapt the image such that the influencer is engaging in an activity relating to the content item or content sponsor (e.g., drinking a cup of coffee if coffee beans are shown in the content item, or if the content sponsor sells coffee, etc.).

Returning now to FIG. 5, at stage 510 of process 500, computing system 104 (e.g., content serving application 154) causes the modified content item (i.e., modified by inserting the influencer image as discussed above) to be served to client device 102 for presentation to the user via display 126. Stage 510 may include directly providing the modified content item to the client device 102, instructing or requesting that another computing system provide the modified content item to the client device 102, or providing the client device 102 with a link that causes the client device 102 to retrieve the modified content item, for example.

It is understood that the various processes shown in FIGS. 2, 5, and/or 6 may have more or fewer elements, and/or occur in a somewhat different order. For example, stage 504 may instead occur after (at least) stage 506, with content selection module 160 computing a relevance score of the content item based in part on which influencer is included in (or at least, selected for future inclusion in) the content item.

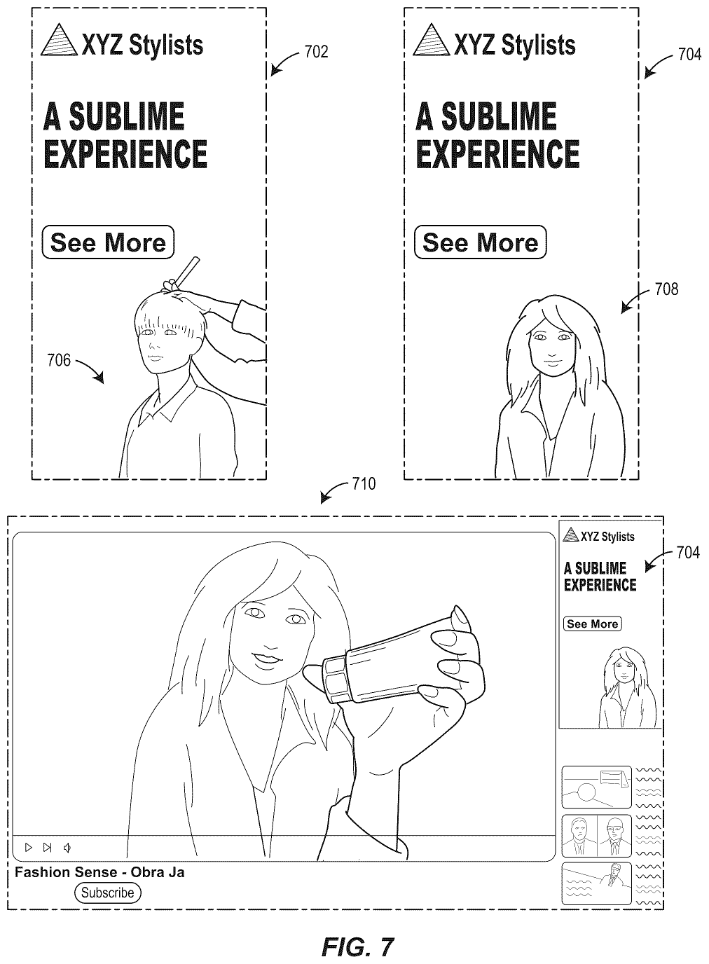

FIG. 7 depicts an example modification, and subsequent presentation, of a content item using the techniques disclosed herein. In FIG. 7, content item 702 may be the content item received at stage 602 of process 600, while modified content item 704 may be the modified content item generated at stage 508, for example. FIG. 7 corresponds to an example in which content modification module 162 uses an object detection model to identify the most prominent person 706 in the content item 702, and surrounds that person 706 with a bounding box that avoids text of the content item, but encompasses other nearby objects (e.g., the arms reaching in from the side of the image). Content modification module 162 then inserts image 708 of the selected influencer and generates appropriate surrounding content. While the depicted example shows blank space around the influencer image 708, a generative AI model can create seamless transitions with far more complex backgrounds. While FIG. 7 shows an example in which a “stand-in” person 706 is replaced with the influencer image, other approaches described herein (e.g., saliency classification) may be preferable to make modification of the original content item 702 (and/or its generation) as simple as possible.

FIG. 7 also depicts an example information resource 710 (e.g., presented on display 126) in which the modified content item may be presented (e.g., as a digital advertisement). In the example shown, the user of client device 102 is viewing a video created by the influencer while being presented, on the right-hand side, with a content item of content sponsor 106 that has been modified so as to show that same influencer. For example, in this scenario, an association between the influencer and the video being watched by the user may have been one of the user signals (or the only user signal) used by content selection module 160, at stage 506 of process 500, to select the influencer for inclusion in the original content item 702.

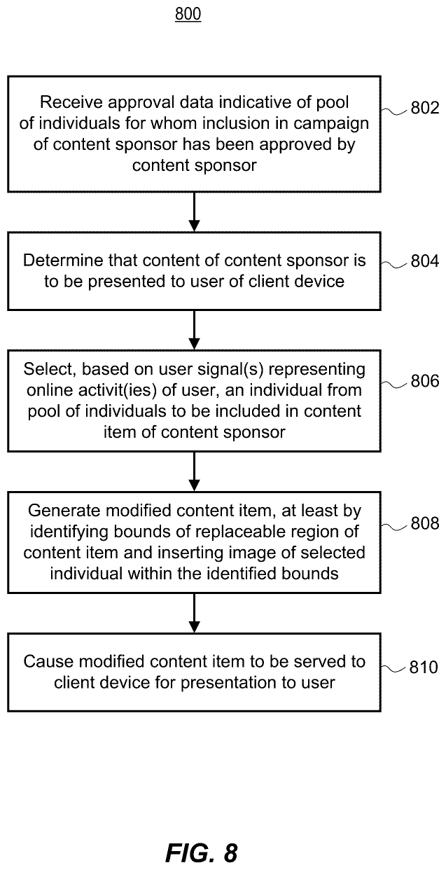

FIG. 8 is a flow diagram of an example method 800 for efficiently connecting with an individual-specific audience. The method 800 may be performed by computing system 104 (e.g., by instructions of content serving application 154, and possibly campaign management application 150 and/or dashboard application 152, when executed by processor 142), or by another suitable computing system.

At block 802, approval data is received (e.g., by campaign management application 150). The approval data is indicative of a pool of individuals for whom inclusion in a campaign of a content sponsor (e.g., content sponsor 106) has been approved by the content sponsor. Block 802 may be similar to stage 502, for example.

At block 804, it is determined (e.g., by content selection module 160) that content of the content sponsor is to be presented to a user of a client device (e.g., client device 102). Block 804 may be similar to stage 504, for example.

At block 806, an individual (e.g., influencer 108) is selected (e.g., by content selection module 160) from the pool of individuals to be included in a content item of the content sponsor, based on one or more user signals representing one or more online activities of the user. Block 806 may be similar to stage 506, for example.

At block 808, a modified content item is generated (e.g., by content modification module 162), at least by identifying bounds of a replaceable region of the content item, and then inserting an image of the selected individual within the identified bounds of the content item. Block 808 may be similar to stage 508 and/or process 600, for example.

At block 810, the modified content item is caused (e.g., by content serving application 154) to be served to the client device for presentation to the user (e.g., via display 126). Block 810 may be similar to stage 510, for example.

The method 800 may include one or more additional blocks. For example, the method 800 may also include a first additional block in which an online dashboard presenting (i) one or more campaigns of one or more content sponsors, and (ii) one or more interactive controls that enable applications for one or more of the one or more campaigns, are provided to computing devices of a plurality of individuals that includes the pool of individuals (e.g., similar to stage 204), a second additional block in which selection data indicating a selection, by each individual of at least the pool of individuals and via the online dashboard, of at least the campaign of the content sponsor is received from computing devices of at least the pool of individuals (e.g., similar to stage 206), and a third additional block in which application data indicating at least the pool of individuals and the campaign is sent to a computing device associated with the content sponsor (e.g., similar to stage 208).

It is understood that the blocks of FIG. 8 need not be performed strictly in the order shown. In some implementations, for example, block 804 may occur contemporaneously with or after block 806.

In some implementations, the techniques disclosed herein use artificial intelligence to facilitate the restructuring of account data. Artificial intelligence (AI) is a segment of computer science that focuses on the creation of models that can perform tasks with little to no human intervention. Artificial intelligence systems can utilize, for example, machine learning, natural language processing, and computer vision. Machine learning, and its subsets, such as deep learning, focus on developing models that can infer outputs from data. The outputs can include, for example, predictions and/or classifications. Natural language processing focuses on analyzing and generating human language. Computer vision focuses on analyzing and interpreting images and videos. Artificial intelligence systems can include generative models that generate new content, such as images, videos, text, audio, and/or other content, in response to input prompts and/or based on other information.

Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some machine-learned models can include multi-headed self-attention models (e.g., transformer models).

The model(s) can be trained using various training or learning techniques. The training can implement supervised learning, unsupervised learning, reinforcement learning, etc. The training can use techniques such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations. A number of generalization techniques (e.g., weight decays, dropouts) can be used to improve the generalization capability of the models being trained.

The model(s) can be pre-trained before domain-specific alignment. For instance, a model can be pretrained over a general corpus of training data and fine-tuned on a more targeted corpus of training data. A model can be aligned using prompts that are designed to elicit domain-specific outputs. Prompts can be designed to include learned prompt values (e.g., soft prompts). The trained model(s) may be validated prior to their use using input data other than the training data, and may be further updated or refined during their use based on additional feedback/inputs.

In some implementations, the computing system 104 may use any one or more the machine learning models noted above to perform any one or more of the operations discussed herein in connection with machine learning. For example, content selection module 160 may use one or more such machine learning models to select a particular individual (e.g., influencer) for inclusion in a content item, and/or content modification module 162 may use one or more such machine learning models to generate the portions of an image between a bounding box and the inserted image of the individual, etc.

Although the foregoing text sets forth a detailed description of numerous different aspects and implementations of the invention, it should be understood that the scope of the patent is defined by the words of the claims set forth at the end of this patent. The detailed description is to be construed as exemplary only and does not describe every possible implementation because describing every possible implementation would be impractical, if not impossible. Numerous alternative implementations could be implemented, using either current technology or technology developed after the filing date of this patent, which would still fall within the scope of the claims. The disclosure herein contemplates at least the following examples:

Example 1. A method for increasing content interactions of users, the method comprising: receiving, by one or more processors, approval data indicative of a pool of individuals for whom inclusion in a campaign of a content sponsor has been approved by the content sponsor; determining, by the one or more processors, that content of the content sponsor is to be presented to a user of a client device; selecting, by the one or more processors and based on one or more user signals representing one or more online activities of the user, an individual from the pool of individuals to be included in a content item of the content sponsor; generating, by the one or more processors, a modified content item, at least by identifying bounds of a replaceable region of the content item, and inserting an image of the selected individual within the identified bounds of the content item; and causing, by the one or more processors, the modified content item to be served to the client device for presentation to the user.

Example 2. The method of example 1, further comprising: providing, by the one or more processors and to computing devices of a plurality of individuals that includes the pool of individuals, an online dashboard presenting (i) one or more campaigns of one or more content sponsors, and (ii) one or more interactive controls that enable applications for one or more of the one or more campaigns; receiving, by the one or more processors and from computing devices of at least the pool of individuals, selection data indicating a selection, by each individual of at least the pool of individuals and via the online dashboard, of at least the campaign of the content sponsor; and sending, by the one or more processors and to a computing device associated with the content sponsor, application data indicating at least (i) the pool of individuals and (ii) the campaign, wherein receiving the approval data includes receiving the approval data indicative of the pool of individuals from the content sponsor in response to sending the application data.

Example 3. The method of example 1 or 2, wherein selecting the individual includes inputting the one or more user signals into a trained deep neural network.

Example 4. The method of any one of examples 1-3, wherein the one or more user signals representing one or more online activities of the user include: data indicative of a subscription of the user.

Example 5. The method of any one of examples 1-3, wherein the one or more user signals representing one or more online activities of the user include one or more of: data indicative of one or more videos previously watched by the user; data indicative of how much or how often the user watched the one or more videos; or data indicative of a video currently being watched by the user.

Example 6. The method of any one of examples 1-3, wherein the one or more user signals representing one or more online activities of the user include: data indicative of an information resource currently being accessed by the user via the client device.

Example 7. The method of any one of examples 1-3, wherein selecting the individual is further based on one or more of: data indicative of the content item; data indicative of a landing page associated with the content item; or data indicative of the content sponsor.

Example 8. The method of any one of examples 1-7, wherein identifying the bounds of the replaceable region includes: using a saliency classification model to identify a low-saliency area of the content item in which to insert the image of the selected individual.

Example 9. The method of any one of examples 1-8, wherein identifying the bounds of the replaceable region includes: using a digital indication provided by the content sponsor to identify an area of the content item in which to insert the image of the selected individual.

Example 10. The method of any one of examples 1-9, wherein generating the modified content item further includes: generating, using a generative artificial intelligence (AI) model, surrounding content that fills at least an area between the identified bounds and the inserted image.

Example 11. The method of example 10, wherein the generative AI model includes an image-generating large language model (LLM).

Example 12. The method of any one of examples 1-9, wherein generating the modified content item further includes: modifying, using a generative artificial intelligence (AI) model, text of the content item based on information associated with the selected individual, the text of the content item being outside of the identified bounds.

Example 13. The method of any one of examples 1-9, wherein generating the modified content item further includes: modifying, using a generative artificial intelligence (AI) model, the image of the individual based on one or both of the content item and the content sponsor.

Example 14. The method of any one of examples 1-13, wherein determining that content of the content sponsor is to be presented to the user of the client device occurs after selecting the individual from the pool of individuals.

Example 15. A system comprising: one or more processors; and one or more non-transitory computer-readable media storing instructions that, when executed by the one or more processors, cause the one or more processors to: receive approval data indicative of a pool of individuals for whom inclusion in a campaign of a content sponsor has been approved by the content sponsor, determine that content of the content sponsor is to be presented to a user of a client device, select, based on one or more user signals representing one or more online activities of the user, an individual from the pool of individuals to be included in a content item of the content sponsor, generate a modified content item, at least by (i) identifying bounds of a replaceable region of the content item, and (ii) inserting an image of the selected individual within the identified bounds of the content item, and cause the modified content item to be served to the client device for presentation to the user.

Example 16. The system of example 15, wherein selecting the individual includes inputting the one or more user signals into a trained deep neural network.

Example 17. The system of example 15 or 16, wherein the one or more user signals representing one or more online activities of the user include one or more of: data indicative of a subscription of the user; data indicative of one or more videos previously watched by the user; data indicative of how much or how often the user watched the one or more videos; or data indicative of a video currently being watched by the user.

Example 18. One or more non-transitory computer-readable media storing instructions that, when executed by one or more processors, cause the one or more processors to: receive approval data indicative of a pool of individuals for whom inclusion in a campaign of a content sponsor has been approved by the content sponsor; determine that content of the content sponsor is to be presented to a user of a client device; select, based on one or more user signals representing one or more online activities of the user, an individual from the pool of individuals to be included in a content item of the content sponsor; generate a modified content item, at least by identifying bounds of a replaceable region of the content item, and inserting an image of the selected individual within the identified bounds of the content item; and cause the modified content item to be served to the client device for presentation to the user.

Example 19. The one or more non-transitory computer-readable media of example 18, wherein selecting the individual includes inputting the one or more user signals into a trained deep neural network.

Example 20. The one or more non-transitory computer-readable media of example 18 or 19, wherein the one or more user signals representing one or more online activities of the user include one or more of: data indicative of a subscription of the user; data indicative of one or more videos previously watched by the user; data indicative of how much or how often the user watched the one or more videos; or data indicative of a video currently being watched by the user.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first set of one or more processors (e.g., in a first computing device) generates X and an entirely distinct, second set of one or more processors (e.g., in a different, second computing device) independently generates Y; (2) implementations in which all processors in the set of one or more processors (e.g., all in the same device, or distributed among multiple devices) contribute to the generation of both X and Y; and (3) other variations.

Unless specifically stated otherwise, discussions in the present disclosure using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used in the present disclosure any reference to “one implementation” or “an implementation” means that a particular element, feature, structure, or characteristic described in connection with the implementation is included in at least one implementation or implementation. The appearances of the phrase “in one implementation” in various places in the specification are not necessarily all referring to the same implementation.

As used in the present disclosure, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs through the principles described herein. Thus, while particular implementations and applications have been illustrated and described, it is to be understood that the disclosed implementations are not limited to the precise construction and components disclosed in the present disclosure. Various modifications, changes and variations, which will be apparent to those skilled in the art, may be made in the arrangement, operation and details of the method and apparatus disclosed in the present disclosure without departing from the spirit and scope defined in the appended claims.

What is claimed is:

1. A method for increasing content interactions of users, the method comprising:
receiving, by one or more processors, approval data indicative of a pool of individuals for whom inclusion in a campaign of a content sponsor has been approved by the content sponsor;
determining, by the one or more processors, that content of the content sponsor is to be presented to a user of a client device;
selecting, by the one or more processors and based on one or more user signals representing one or more online activities of the user, an individual from the pool of individuals to be included in a content item of the content sponsor;
generating, by the one or more processors, a modified content item, at least by
identifying bounds of a replaceable region of the content item, and
inserting an image of the selected individual within the identified bounds of the content item; and
causing, by the one or more processors, the modified content item to be served to the client device for presentation to the user.

2. The method of claim 1, further comprising:
providing, by the one or more processors and to computing devices of a plurality of individuals that includes the pool of individuals, an online dashboard presenting (i) one or more campaigns of one or more content sponsors, and (ii) one or more interactive controls that enable applications for one or more of the one or more campaigns;
receiving, by the one or more processors and from computing devices of at least the pool of individuals, selection data indicating a selection, by each individual of at least the pool of individuals and via the online dashboard, of at least the campaign of the content sponsor; and
sending, by the one or more processors and to a computing device associated with the content sponsor, application data indicating at least (i) the pool of individuals and (ii) the campaign,
wherein receiving the approval data includes receiving the approval data indicative of the pool of individuals from the content sponsor in response to sending the application data.

3. The method of claim 1, wherein selecting the individual includes inputting the one or more user signals into a trained deep neural network.

4. The method of claim 1, wherein the one or more user signals representing one or more online activities of the user include:
data indicative of a subscription of the user.

5. The method of claim 1, wherein the one or more user signals representing one or more online activities of the user include one or more of:
data indicative of one or more videos previously watched by the user;
data indicative of how much or how often the user watched the one or more videos; or
data indicative of a video currently being watched by the user.

6. The method of claim 1, wherein the one or more user signals representing one or more online activities of the user include:
data indicative of an information resource currently being accessed by the user via the client device.

7. The method of claim 1, wherein selecting the individual is further based on one or more of:
data indicative of the content item;
data indicative of a landing page associated with the content item; or
data indicative of the content sponsor.

8. The method of claim 1, wherein identifying the bounds of the replaceable region includes:
using a saliency classification model to identify a low-saliency area of the content item in which to insert the image of the selected individual.

9. The method of claim 1, wherein identifying the bounds of the replaceable region includes:
using a digital indication provided by the content sponsor to identify an area of the content item in which to insert the image of the selected individual.

10. The method of claim 1, wherein generating the modified content item further includes:
generating, using a generative artificial intelligence (AI) model, surrounding content that fills at least an area between the identified bounds and the inserted image.

11. The method of claim 10, wherein the generative AI model includes an image-generating large language model (LLM).

12. The method of claim 1, wherein generating the modified content item further includes:
modifying, using a generative artificial intelligence (AI) model, text of the content item based on information associated with the selected individual, the text of the content item being outside of the identified bounds.

13. The method of claim 1, wherein generating the modified content item further includes:
modifying, using a generative artificial intelligence (AI) model, the image of the individual based on one or both of the content item and the content sponsor.

14. The method of claim 1, wherein determining that content of the content sponsor is to be presented to the user of the client device occurs after selecting the individual from the pool of individuals.

15. A system comprising:
one or more processors; and
one or more non-transitory computer-readable media storing instructions that, when executed by the one or more processors, cause the one or more processors to:
receive approval data indicative of a pool of individuals for whom inclusion in a campaign of a content sponsor has been approved by the content sponsor,
determine that content of the content sponsor is to be presented to a user of a client device,
select, based on one or more user signals representing one or more online activities of the user, an individual from the pool of individuals to be included in a content item of the content sponsor,
generate a modified content item, at least by
(i) identifying bounds of a replaceable region of the content item, and
(ii) inserting an image of the selected individual within the identified bounds of the content item, and
cause the modified content item to be served to the client device for presentation to the user.

16. The system of claim 15, wherein selecting the individual includes inputting the one or more user signals into a trained deep neural network.

17. The system of claim 15, wherein the one or more user signals representing one or more online activities of the user include one or more of:
data indicative of a subscription of the user;
data indicative of one or more videos previously watched by the user;
data indicative of how much or how often the user watched the one or more videos; or
data indicative of a video currently being watched by the user.

18. One or more non-transitory computer-readable media storing instructions that, when executed by one or more processors, cause the one or more processors to:
receive approval data indicative of a pool of individuals for whom inclusion in a campaign of a content sponsor has been approved by the content sponsor;
determine that content of the content sponsor is to be presented to a user of a client device;
select, based on one or more user signals representing one or more online activities of the user, an individual from the pool of individuals to be included in a content item of the content sponsor;
generate a modified content item, at least by
identifying bounds of a replaceable region of the content item, and
inserting an image of the selected individual within the identified bounds of the content item; and
cause the modified content item to be served to the client device for presentation to the user.

19. The one or more non-transitory computer-readable media of claim 18, wherein selecting the individual includes inputting the one or more user signals into a trained deep neural network.

20. The one or more non-transitory computer-readable media of claim 18, wherein the one or more user signals representing one or more online activities of the user include one or more of:
data indicative of a subscription of the user;
data indicative of one or more videos previously watched by the user;
data indicative of how much or how often the user watched the one or more videos; or
data indicative of a video currently being watched by the user.
